(19) United States
(12) Patent Application Publication
(10) Pub. No.: US 2011/0242423 A1
(43) Pub. Date: Oct. 6, 2011

(54) Method and Apparatus for Motion Detection

(76) Inventors: Tung-Hsin Lee, Hsinchu City (TW); Chun-Cheng Chiang, Hsinchu City (TW)

(21) Appl. No.: 12/797,592

(22) Filed: Jun. 9, 2010

(30) Foreign Application Priority Data
Mar. 30, 2010 (TW) 099109572

(51) Int. Cl. H04N 5/14

(52) U.S. Cl. 348/619; 348/699; 348/E05.066; 348/E05.062

(57) ABSTRACT

A motion detection method includes steps of receiving a previous frame and a current frame, calculating a pixel value difference of a target pixel between the previous frame and the current frame to determine a temporal pixel difference, calculating pixel value differences between the target pixel and surrounding pixels of the target pixel in the previous frame and the current frame, respectively, to determine a spatial pixel difference, and dividing the temporal pixel difference by the spatial pixel difference to determine a motion value of the target pixel.

### BACKGROUND OF THE INVENTION

1. Field of the Invention

The present invention relates to a method and an apparatus for motion detection, and more particularly, to a method and an apparatus capable of estimating a motion level of a target pixel via a temporal pixel difference and a spatial pixel difference.

2. Description of the Prior Art

Video noises are easily generated due to video acquisition, recording, and transmission, and may further affect subsequent processing results. Hence, noise reduction is a very important task in video processing. In general, noise reduction methods are divided into two categories: spatial noise reduction and temporal noise reduction. For static frames, performing noise reduction by temporal correlations retains more details than by spatial image characteristics. On the contrary, for motion frames, performing noise reduction by temporal correlations would result in residual images. However, since moving images may have slightly blurred details, performing noise reduction by spatial image characteristics would not have serious side effects instead. Hence, video filters have to operate both in spatial and temporal domains to accurately eliminate the noises.

Please refer to FIG. 1. FIG. 1 is a schematic diagram of a conventional noise reduction device 10. The noise reduction device 10 is utilized for eliminating noises in a video processing system, and includes a spatial filter 12, a temporal filter 14, a motion detection unit 16, and an output terminal 18. The spatial filter 12 is utilized for performing two-dimension low-pass filtering on pixel data of a current frame f(t), to eliminate spatial noises in the current frame f(t). The motion detection unit 16 is utilized for determining a motion level of the current frame f(t), which generates a motion estimation value of the current frame f(t) through comparing pixel data of the current frame f(t) and a previous frame f(t−1). According to the motion estimation value, the temporal filter 14 then performs filtering on the pixel data of the current frame f(t) to generate a filtering result f″(t). When the current frame f(t) is a motion frame, the temporal filter 14 adopts the two-dimension low-pass filtering result, outputted from the spatial filter 12, as the filtering result f″ (t) of the current frame; and when the current frame f(t) is a static frame, the temporal filter 14 performs three-dimension filtering on the pixel data of the previous frame f(t−1) and the current frame f(t), to generate the filtering result f″(t) of the current frame.

In other words, the motion detection unit 16 determines the motion level of the current frame f(t), and the temporal filter 14 performs proper filtering on the current frame f(t) according to the motion level of the current frame f(t). As a result, the noise reduction device 10 can efficiently eliminate noises, improve image qualities, and further retain definition of static frames.

As mention above, when performing noise filtering on video signals, the prior art requires to estimate the motion level of the current frame to determine that the filtering result of the current frame is the spatial filtering result, the temporal filtering result, or specific blending of the spatial and temporal filtering results. Currently, motion detection techniques for noise elimination in the industry are separated into two categories. One is to represent the motion level of the pixel by pixel value differences between the previous frame and the current frame. However, although a pixel movement causes a pixel value difference between the neighboring frames, a pixel value difference may not necessarily indicate a visible pixel movement. Hence, performing motion detecting in this way often generates wrong decisions.

The other is to adopt motion estimation and motion compensation (MEMC) methods to eliminate noises in temporal domain. However, the motion compensation method has complex operations, higher costs, and only suits to high-end applications.

### SUMMARY OF THE INVENTION

It is therefore an objective of the claimed invention to provide a method and an apparatus for motion detection.

The present invention discloses a motion detection method for a video system, which includes steps of receiving a previous frame and a current frame, calculating a pixel value difference of a target pixel between the current frame and the previous frame, to determine a temporal pixel difference, calculating pixel value differences between the target pixel and surrounding pixels of the target pixel in the previous frame and the current frame, respectively, to determine a spatial pixel difference, and dividing the temporal pixel difference by the spatial pixel difference, to determine a motion value of the target pixel.

The present invention further discloses a motion detection device for a video processing system, which includes a first input terminal, for receiving a previous frame, a second input terminal, for receiving a current frame, a temporal difference calculation unit, a spatial difference calculation unit, and a motion estimation unit. The temporal difference calculation unit, coupled to the first input terminal and the second input terminal, is utilized for calculating a pixel value difference of a target pixel between the current frame and the previous frame, to determine a temporal pixel difference. The spatial difference calculation unit, coupled to the first input terminal and the second input terminal, is utilized for calculating pixel value differences between the target pixel and surrounding pixels of the target pixel in the previous frame and the current frame, respectively, to determine a spatial pixel difference. Finally, the motion estimation unit, coupled to the temporal difference calculation unit and the spatial difference calculation unit, is utilized for dividing the temporal pixel difference by the spatial pixel difference, to determine a motion value of the target pixel

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional noise reduction device.

FIG. 2 is a schematic diagram of a motion detection device according to the present invention.

FIG. 3 illustrates a motion detection method of the present invention.

FIG. 4 is a schematic diagram of a spatial difference calculation unit of FIG. 3 according to an embodiment of the present invention.

FIG. 5 and FIG. 6 is a normalization look-up table of the present invention, respectively.

FIG. 7 is a schematic diagram of a motion detection process according to an embodiment of the present invention.

### DETAILED DESCRIPTION

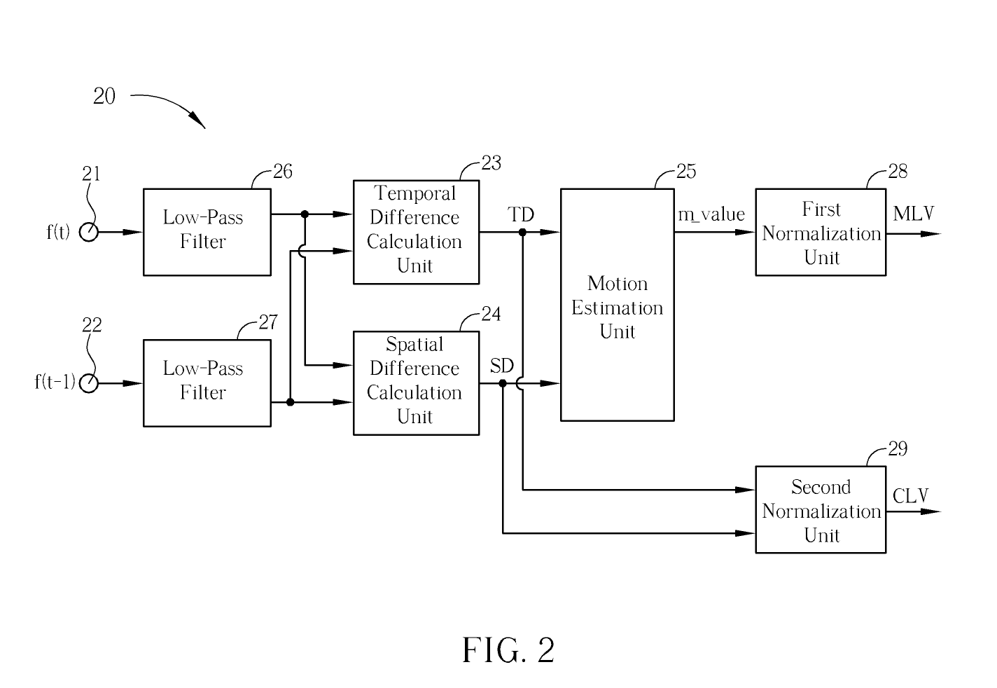

Please refer to FIG. 2. FIG. 2 is a schematic diagram of a motion detection device 20 according to the present invention. The motion detection device 20 is utilized for detecting a motion level of a current frame in a video processing system, and includes input terminals 21 and 22, a temporal difference calculation unit 23, a spatial difference calculation unit 24, and a motion estimation unit 25. The input terminals 21 and 22 are utilized for receiving a previous frame f(t−1) and a current frame f(t), respectively. The previous frame f(t−1) is preferably to be a previous one frame of the current frame f(t), but can also be one of the plural previous frames of the current frame f(t) in other embodiments. The temporal difference calculation unit 23 is coupled to the input terminals 21 and 22, and is utilized for calculating a pixel value difference of a target pixel between the current frame f(t) and the previous frame f(t−1), to determine a temporal pixel difference TD. The spatial difference calculation unit 24 is coupled to the input terminals 21 and 22, and is utilized for calculating a maximum pixel value difference between the target pixel and surrounding pixels (such as eight surrounding pixels) of the target pixel in the previous frame f(t−1) and the current frame f(t), to determine a spatial pixel difference SD. The motion estimation unit 25 is coupled to the temporal difference calculation unit 23 and the spatial difference calculation unit 24, and is utilized for dividing the temporal pixel difference TD by the spatial pixel difference SD, to obtain a motion value m_value of the target pixel.

The motion detection device 20 can further include low-pass filters 26 and 27, coupled to the input terminals 21 and 22, for performing low-pass filtering on the current frame f(t) and the previous frame f(t−1), to avoid the motion detection being affected by the noises. In addition, the said pixel value generally indicates a gray level of a pixel. However, in other embodiments, the pixel value can further indicate pixel information such as luminance, brightness and so on, and is not limited to these.

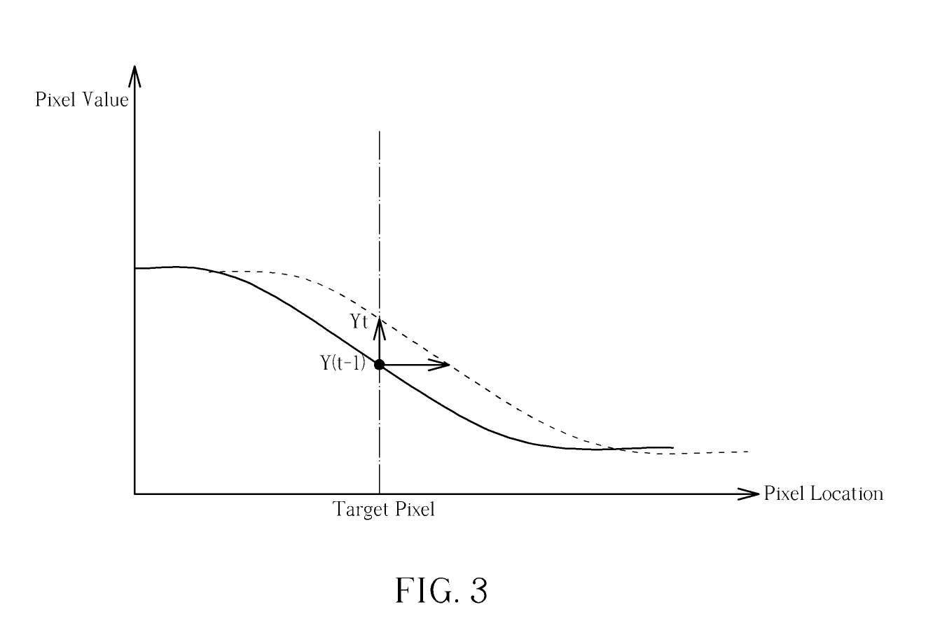

In short, the motion detection device 20 estimates motions of the target pixel via calculating the temporal pixel difference and the spatial pixel difference of the target pixel. As to the concept of the motion detection method, please continue to refer to FIG. 3. In FIG. 3, Y(t) denotes a pixel value of the target pixel in the current frame f(t), and Y(t−1) denotes a pixel value of the target pixel in the previous frame f(t−1). The solid line denotes a pixel-value curve of the target pixel along a particular direction in the previous frame f(t−1), and the dotted line denotes a pixel-value curve of the target pixel along the same direction in the current frame f(t). As shown, from the previous frame f(t−1) to the current frame f(t), the pixel-value curve shifts from the solid line to the dotted line, such that the pixel value of the target pixel changes from Y(t−1) to Y(t). Because the pixel-value curves along the same direction would not change too much in the neighboring frames, if a pixel-value gradient of the target pixel (i.e. pixel value difference per pixel interval) in the previous frame f(t−1) or the current frame f(t) can be known, with the already known temporal pixel difference (i.e. |Y(t)−Y(t−1) |), the motion value of the target pixel between the previous frame f(t−1) and the current frame f(t) can be estimated, as indicated by the horizontal arrow in FIG. 3.

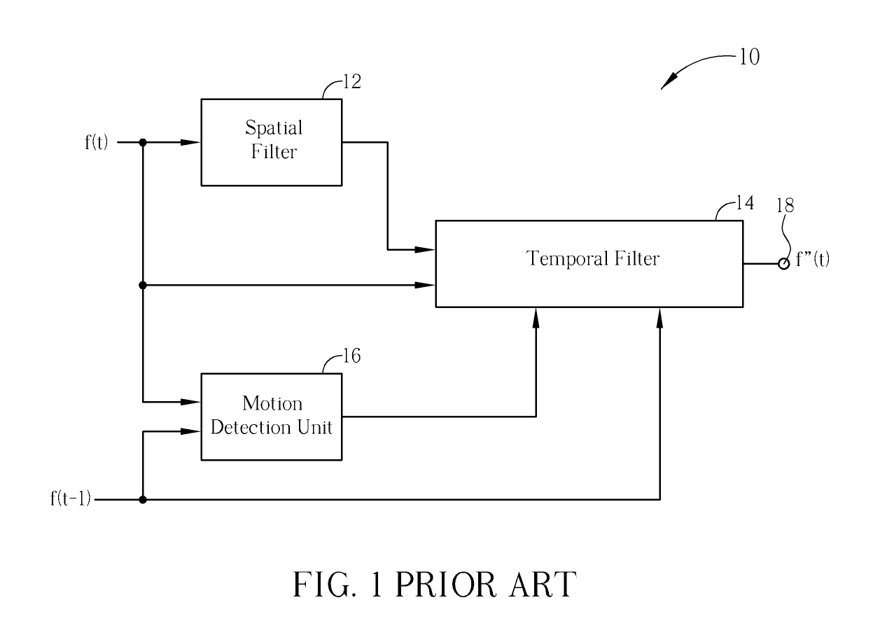

Therefore, the present invention calculates the maximum pixel value differences between the target pixel and the eight surrounding pixels of the target pixel in the previous frame f(t−1) and the current frame f(t), respectively , so as to obtain the pixel-value gradient in the two dimensional plane. Because the pixel-value gradient can be obtained either from the previous frame f(t−1) or the current frame f(t), the present invention selects a minimum of the two pixel-value gradients to be the possible pixel-value gradient (i.e. the spatial pixel difference SD of FIG. 1), in order to anticipate that a maximum motion value m_value can be obtained.

Moreover, the temporal pixel difference TD can be obtained via calculating the pixel value difference of the target pixel between the current frame f(t) and the previous frame f(t−1) (i.e. |Y(t)−Y(t−1)|). Hence, the motion value of the target pixel is obtained after dividing the temporal pixel difference TD by the spatial pixel difference SD, which indicates the number of pixel intervals the target pixel moves. Compared to the prior art, although the two techniques both adopt the pixel value differences to estimate motions, the present invention can enhance estimation accuracy without increasing system complexity.

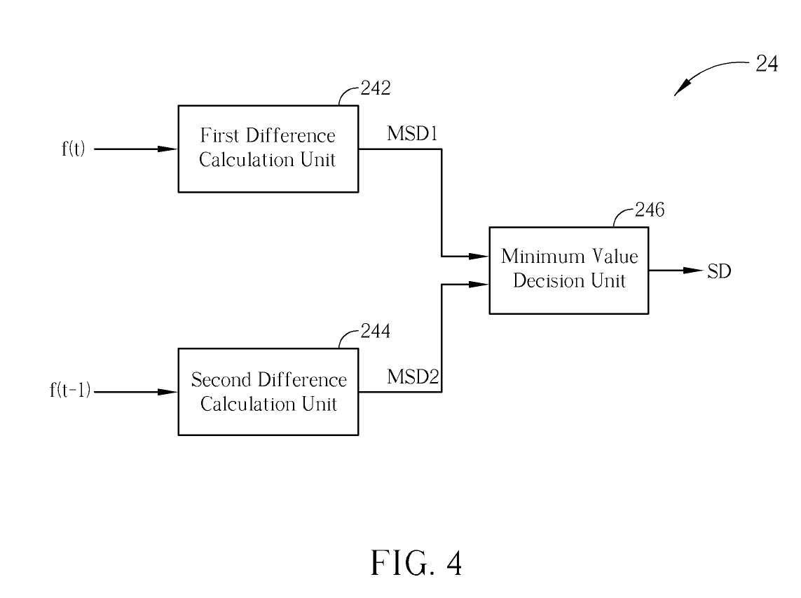

Please refer to FIG. 4. FIG. 4 is a schematic diagram of the spatial difference calculation unit 24 according to an embodiment of the present invention. The spatial difference calculation unit 24 includes a first difference calculation unit 242, a second difference calculation unit 244, and a minimum value decision unit 246. The first difference calculation unit 242 is coupled to the input terminal 21, and is utilized for calculating the pixel value differences between the target pixel and the surrounding pixels of the target pixel in the current frame f(t), to obtain a maximum pixel value difference MSD1 of the current frame f(t). The second difference calculation unit 244 is coupled to the input terminal 22, and is utilized for calculating the pixel value differences between the target pixel and the surrounding pixels of the target pixel in the previous frame f(t−1), to obtain a maximum pixel value difference MSD2 of the previous frame f(t−1). The minimum value decision unit 246 is coupled to the first difference calculation unit 242 and the second difference calculation unit 244, and is utilized for selecting a minimum value of the maximum pixel value differences MSD1 and MSD2, such that the minimum value can be outputted as the spatial pixel difference SD.

Preferably, the motion detection device 20 can further normalize the motion value m_value, outputted from the motion estimation unit 25, to determine a motion level of the target pixel. Besides, if the spatial pixel difference SD or the temporal pixel difference TD is great enough, the motion value m_value, outputted from the motion estimation unit 25, can be considered as a reasonable estimation value. Hence, the motion detection device 20 can further normalize the sum of the spatial pixel difference SD and the temporal pixel difference TD, to be a basis for credibility.

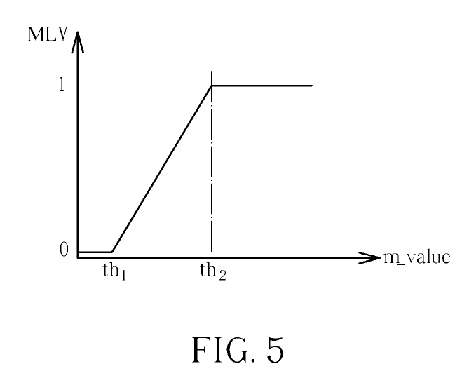

Under such a situation, the motion detection device 20 can further include a first normalization unit 28 and a second normalization unit 29, as shown in FIG. 2. The first normalization unit 28 can be implemented by a look-up table shown in FIG. 5. When the motion value m_value is greater than a threshold th2, the motion level MLV of the target value is determined to be 1; when the motion value m_value is smaller than a threshold th1, the motion level MLV of the target value is determined to be 0; and when the motion value m_value is between the thresholds th1 and th2, the motion level MLV of the target value is determined to be an interpolation result between 0 and 1. That is to say, when the target pixel moves a distance less than th1 pixel intervals, the motion detection unit 20 determines that the target pixel is static, and when the target pixel moves a distance more than th2 pixel intervals, the motion detection unit 20 determines that the target pixel has a movement between the neighboring frames.

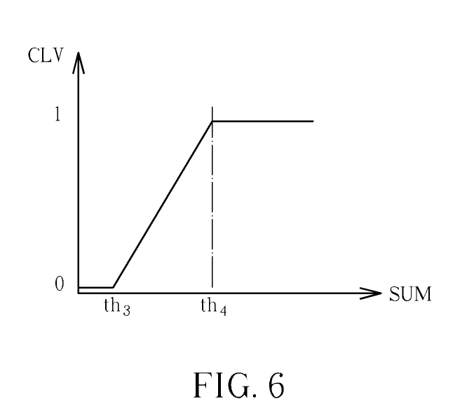

Similarly, the second normalization unit 29 can be implemented by a look-up table shown in FIG. 6. When the sum of the spatial pixel difference SD and the temporal pixel difference TD is greater than a threshold th4, a confidence level of the motion value m_value is 1, and when the sum is smaller than a threshold th3, the confidence level of the motion value m_value is 0. That is to say, when both the spatial pixel difference SD and the temporal pixel difference TD are small, the motion value m_value is considered unbelievable or the target pixel is considered to be static.

As a result, based on the motion level MLV and the confidence level CLV calculated by the motion detection device 20, a video system can perform spatial filtering, temporal filtering, or a specific blending of the spatial and temporal filtering to eliminate noises of the target pixel accordingly.

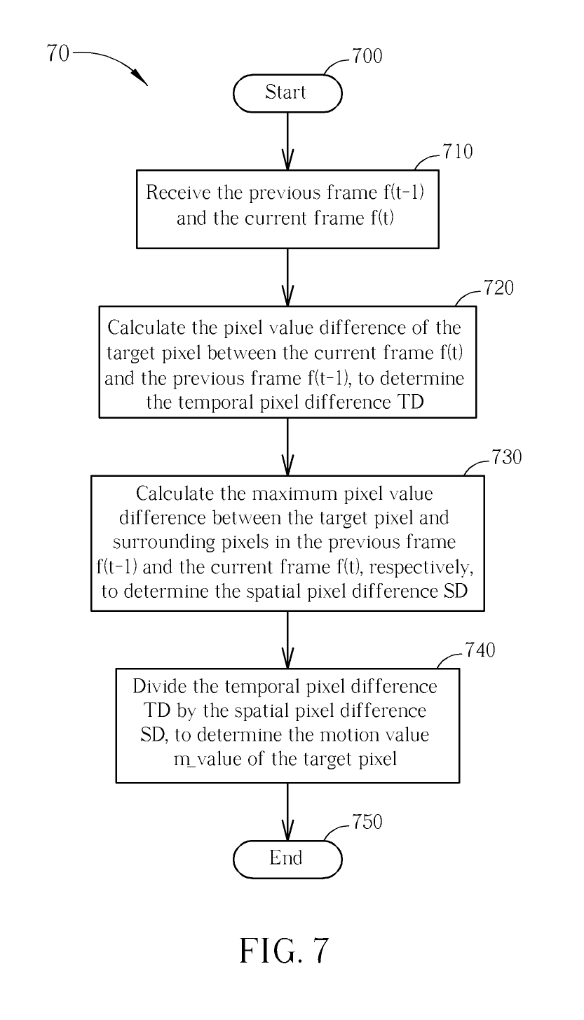

Please refer to FIG. 7. FIG. 7 is a schematic diagram of a motion detection process 70 according to an embodiment of the present invention. The motion detection process 70 is an operation process of the above motion detection device 20, and includes the following steps:

Step 700: Start.

Step 710: Receive the previous frame f(t−1) and the current frame f(t).

Step 720: Calculate the pixel value difference of the target pixel between the current frame f(t) and the previous frame f(t−1), to determine the temporal pixel difference TD.

Step 730: Calculate the maximum pixel value difference between the target pixel and the surrounding pixels in the previous frame f(t−1) and the current frame f(t), respectively, to determine the spatial pixel difference SD.

Step 740: Divide the temporal pixel difference TD by the spatial pixel difference SD, to determine the motion value m_value of the target pixel.

Step 750: End.

According to the motion detection process 70, the motion detection device 20 first calculates the pixel value difference between the current frame f(t) and the previous frame f(t−1) (i.e. |Y(t)−Y(t−1)|), to obtain the temporal pixel difference TD. Then, the motion detection device 20 calculates the maximum pixel value difference between the target pixel and the surrounding pixels of the target pixel in the previous frame f(t−1) and the current frame f(t), respectively, to obtain a two-dimension pixel-value gradient. Finally, the motion detection device 20 divides the temporal pixel difference TD by the spatial pixel difference SD, to estimate the motion value of the target pixel, which means the number of pixel intervals the target pixel moves. The detailed operations of the motion detection device 20 have been illustrated in the above, and thus are not narrated again herein.

To sum up, the present invention estimates motions of the target pixel primarily via the temporal pixel difference between the neighboring frames and the pixel-value gradient represented by the spatial pixel difference. Compared to the prior art, although the pixel value differences are still used to estimate the pixel motions, the present invention further enhances estimation accuracy without increasing system complexity.

Those skilled in the art will readily observe that numerous modifications and alterations of the device and method may be made while retaining the teachings of the invention.

What is claimed is:

1. A motion detection method for a video processing system, the method comprising:
receiving a previous frame and a current frame;
calculating a pixel value difference of a target pixel between the current frame and the previous frame, to determine a temporal pixel difference;
calculating pixel value differences between the target pixel and surrounding pixels of the target pixel in the previous frame and the current frame, respectively, to determine a spatial pixel difference; and
dividing the temporal pixel difference by the spatial pixel difference, to determine a motion value of the target pixel.

2. The motion detection method of claim 1, wherein the step of determining the spatial pixel difference of the target pixel further comprises:
calculating a maximum pixel value difference of the previous frame according to the pixel value differences between the target pixel and the surrounding pixels of the target pixel in the previous frame;
calculating a maximum pixel value difference of the current frame according to the pixel value differences between the target pixel and the surrounding pixels of the target pixel in the current frame; and
comparing the maximum pixel value differences of the previous frame and the current frame, to obtain a minimum value, and using the minimum value as the spatial pixel difference.

3. The motion detection method of claim 1 further comprising:
normalizing the motion value according to a look-up table, to determine a motion level of the target pixel.

4. The motion detection method of claim 3, wherein the look-up table determines the motion level of the target pixel to be 0 when the motion value is less than a first threshold, and determines the motion level of the target pixel to be 1 when the motion value is greater than a second threshold.

5. The motion detection method of claim 1 further comprising:
normalizing a sum of the temporal pixel difference and the spatial pixel difference according to a look-up table, to determine a confidence level of the motion value.

6. The motion detection method of claim 5, wherein the look-up table determines the confidence level of the motion value to be 0 when the sum is less than a third threshold, and determines the confidence level of the motion value to be 1 when the sum is greater than a fourth threshold.

7. The motion detection method of claim 1 further comprising:
performing low-pass filtering on the current frame and the previous frame, to reduce the effect of noises.

8. The motion detection method of claim 1, wherein the previous frame is a previous one frame of the current frame.

9. A motion detection device for a video processing system, comprising:
a first input terminal, for receiving a previous frame;
a second input terminal, for receiving a current frame;
a temporal difference calculation unit, coupled to the first input terminal and the second input terminal, for calculating a pixel value difference of a target pixel between the current frame and the previous frame, to determine a temporal pixel difference;
a spatial difference calculation unit, coupled to the first input terminal and the second input terminal, for calculating pixel value differences between the target pixel and surrounding pixels of the target pixel in the previous frame and the current frame, respectively, to determine a spatial pixel difference; and
a motion estimation unit, coupled to the temporal difference calculation unit and the spatial difference calculation unit, for dividing the temporal pixel difference by the spatial pixel difference, to determine a motion value of the target pixel.

10. The motion detection device of claim 9, wherein the spatial difference calculation unit further comprises:
a first difference calculation unit, coupled to the first input terminal, for calculating the pixel value differences between the target pixel and the surrounding pixels of the target pixel in the previous frame, to obtain a maximum pixel value difference of the previous frame;
a second difference calculation unit, coupled to the second input terminal, for calculating the pixel value differences between the target pixel and the surrounding pixels of the target pixel in the current frame, to obtain a maximum pixel value difference of the current frame; and
a minimum value decision unit, coupled to the first difference calculation unit and the second difference calculation unit, for determining a minimum value of the maximum pixel value differences of the previous frame and the current frame, and outputting the minimum value as the spatial pixel difference.

11. The motion detection device of claim 9, wherein the motion estimation unit comprises:
a first normalization unit, coupled to the temporal difference calculation unit and the spatial difference calculation unit, for normalizing the motion value according to a look-up table, to determine a motion level of the target pixel.

12. The motion detection device of claim 11, wherein the look-up table determines the motion level of the target pixel to be 0 when the motion value is less than a first threshold, and determines the motion level of the target pixel to be 1, when the motion value is greater than a second threshold.

13. The motion detection device of claim 9, wherein the motion estimation unit comprises:
a second normalization unit, coupled to the temporal difference calculation unit and the spatial difference calculation unit, for normalizing a sum of the temporal pixel difference and the spatial difference according to a look-up table, to determine a confidence level of the motion value.

14. The motion detection device of claim 13, wherein the look-up table determines the confidence level of the motion value to be 0 when the sum is less than a third threshold, and determines the confidence level of the motion value to be 1 when the motion value is greater than a fourth threshold.

15. The motion detection device of claim 9 further comprising:
a first low-pass filter, coupled to the first input terminal, for performing low-pass filtering on the current frame; and
a second low-pass filter, coupled to the second input terminal, for performing low-pass filtering on the previous frame.

16. The motion detection device of claim 9, wherein the previous frame is a previous one frame of the current frame.
